(19) United States
(12) Patent Application Publication
(10) Pub. No.: US 2025/0329277 A1
(43) Pub. Date: Oct. 23, 2025

(54) DISPLAY DEVICE AND ELECTRONIC APPARATUS INCLUDING THE SAME

(71) Applicant: Samsung Display Co., Ltd., Yongin-Si (KR)

(72) Inventors: Junyoung MIN, Yongin-si (KR); Hwayoung SONG, Yongin-si (KR); Hyojoon SONG, Yongin-si (KR); Jun-Yong AN, Yongin-si (KR); Chanyoung YANG, Yongin-si (KR); Junwon CHOI, Yongin-si (KR)

(21) Appl. No.: 19/172,717

(22) Filed: Apr. 8, 2025

(30) Foreign Application Priority Data
Apr. 23, 2024 (KR) 10-2024-0054174

(51) Int. Cl. G09G 3/00

(52) U.S. Cl. CPC G09G 3/006; G09G 2330/021; G09G 2330/12

(57) ABSTRACT

A display device includes first to fifth data lines, a sub-pixel array including first sub-pixels, second sub-pixels, and third sub-pixels, and a lighting test circuit. The sub-pixel array includes a first sub-pixel column disposed adjacent to the first data line and in which first sub-pixels connected to the first data line and third sub-pixels connected to the third data line are alternately arranged, and a third sub-pixel column disposed adjacent to the third data line and in which third sub-pixels connected to the third data line and first sub-pixels connected to the fifth data line are alternately arranged. The lighting test circuit includes a first transistor which outputs a first test voltage to the first data line, and a third transistor which outputs a third test voltage to the third data line.

### CROSS-REFERENCE TO RELATED APPLICATION(S)

This application claims priority under 35 USC § 119 to Korean Patent Application No. 10-2024-0054174 filed on Apr. 23, 2024, in the Korean Intellectual Property Office (KIPO), the entire disclosure of which is incorporated by reference herein.

### BACKGROUND

### 1. Field

Embodiments relate to a display device. More particularly, embodiments relate to a display device including a lighting test circuit and an electronic apparatus including the display device.

### 2. Description of the Related Art

A display device may include a sub-pixel array in which a plurality of sub-pixels are arranged in a plan view. The sub-pixel array may include first sub-pixels emitting light having a first color, second sub-pixels emitting light having a second color, and third sub-pixels emitting light having a third color. The first sub-pixels, the second sub-pixels, and the third sub-pixels may be regularly arranged in a display area to have a stripe type, a PenTile™ type, or the like.

The display device may include a lighting test circuit that performs a lighting test for the sub-pixel array. The lighting test circuit may independently perform a lighting test for the first sub-pixels, a lighting test for the second sub-pixels, and a lighting test for the third sub-pixels. For example, the lighting test circuit may output a test voltage to the first sub-pixels to perform the lighting test for the first sub-pixels, may output the test voltage to the second sub-pixels to perform the lighting test for the second sub-pixels, and may output the test voltage to the third sub-pixels to perform the lighting test for the third sub-pixels.

### SUMMARY

Embodiments provide a display device including a simplified lighting test circuit and an electronic apparatus including the display device.

A display device according to embodiments may include a plurality of data lines extending in a first direction, the plurality of data lines including a first data line, a second data line, a third data line, a fourth data line, a fifth data line, a sixth data line and a seventh data line sequentially disposed in a second direction intersecting the first direction, second sub-pixels which emit light having a second color, and third sub-pixels which emit light having a third color, and a lighting test circuit. The sub-pixel array may include a first sub-pixel column disposed adjacent to the first data line and in which first sub-pixels connected to the first data line and third sub-pixels connected to the third data line are alternately arranged in the first direction, and a third sub-pixel column disposed adjacent to the third data line and in which third sub-pixels connected to the third data line and first sub-pixels connected to the fifth data line are alternately arranged in the first direction. The lighting test circuit may include a first transistor which outputs a first test voltage to the first data line, and a third transistor which outputs a third test voltage to the third data line.

In an embodiment, one of the first sub-pixels in the first sub-pixel column and one of the third sub-pixels in the third sub-pixel column may be disposed in a same row extending in the second direction.

In an embodiment, the sub-pixel array may further include a second sub-pixel column disposed adjacent to the second data line and in which second sub-pixels connected to the second data line are arranged in the first direction.

In an embodiment, the lighting test circuit may further include a second transistor which outputs a second test voltage to the second data line.

In an embodiment, the first transistor, the second transistor, and the third transistor may be turned-on in response to a test gate signal.

In an embodiment, the sub-pixel array may further include a fourth sub-pixel column disposed adjacent to the fourth data line and in which second sub-pixels connected to the fourth data line are arranged in the first direction.

In an embodiment, the lighting test circuit may further include a fourth transistor which outputs a second test voltage to the fourth data line.

In an embodiment, the sub-pixel array may further include a fifth sub-pixel column disposed adjacent to the fifth data line and in which first sub-pixels connected to the fifth data line and third sub-pixels connected to the seventh data line are alternately arranged in the first direction.

In an embodiment, the first sub-pixels in the third sub-pixel column may be connected to the fifth data line.

In an embodiment, the first color may be one of red and blue, the second color may be green, and the third color may be the other of red and blue.

In an embodiment, the first color may be one of green and blue, the second color may be red, and the third color may be the other of green and blue.

In an embodiment, the first color may be one of red and green, the second color may be blue, and the third color may be the other of red and green.

A display device according to embodiments may include a plurality of data lines extending in a first direction, the plurality of data lines including a first data line, a second data line, a third data line, a fourth data line and a fifth data line disposed in a second direction intersecting the first direction, a sub-pixel array including first sub-pixels which emit light having a first color, second sub-pixels which emit light having a second color, and third sub-pixels which emit light having a third color, and a lighting test circuit. The sub-pixel array may include a first sub-pixel column disposed adjacent to the first data line and in which first ones of the first sub-pixels and first ones of the third sub-pixels are alternately arranged in the first direction, a second sub-pixel column disposed adjacent to the second data line and in which first ones of the second sub-pixels are arranged in the first direction, and a third sub-pixel column disposed adjacent to the third data line and in which second ones of the third sub-pixels and second ones of the first sub-pixels are alternately arranged in the first direction. The lighting test circuit may include a first transistor which outputs a first test voltage to the first data line in response to a test gate signal, a second transistor which outputs a second test voltage to the second data line in response to the test gate signal, and a third transistor which outputs a third test voltage to the third data line in response to the test gate signal.

In an embodiment, one of the first sub-pixels in the first sub-pixel column and one of the third sub-pixels in the third sub-pixel column may be disposed in a same row extending in the second direction.

In an embodiment, the sub-pixel array may further include a fourth sub-pixel column disposed adjacent to the fourth data line and in which second ones of the second sub-pixels are arranged in the first direction.

In an embodiment, the lighting test circuit may further include a fourth transistor which outputs the second test voltage to the fourth data line in response to the test gate signal.

In an embodiment, the sub-pixel array may further include a fifth sub-pixel column disposed adjacent to the fifth data line and in which third ones of the first sub-pixels and third ones of the third sub-pixels are alternately arranged in the first direction.

In an embodiment, the first ones of the first sub-pixels in the first sub-pixel column may be connected to the first data line. The first ones of the third sub-pixels in the first sub-pixel column and the second ones of the third sub-pixels in the third sub-pixel column may be connected to the third data line. The second ones of the first sub-pixels in the third sub-pixel column may be connected to the fifth data line.

In an embodiment, the first color may be one of red and blue, the second color may be green, and the third color may be the other of red and blue.

In an electronic apparatus including a display device which displays an image and a processor which controls the display device according to embodiments, the display device may include a first data line, a second data line, a third data line, a fourth data line and a fifth data line extending in a first direction, a sub-pixel array including first sub-pixels which emit light having a first color, second sub-pixels which emit light having a second color, and third sub-pixels which emit light having a third color, and a lighting test circuit. The sub-pixel array may include a first sub-pixel column disposed adjacent to the first data line and in which first sub-pixels connected to the first data line and third sub-pixels connected to the third data line are alternately arranged in the first direction, and a third sub-pixel column disposed adjacent to the third data line and in which third sub-pixels connected to the third data line and first sub-pixels connected to the fifth data line are alternately arranged in the first direction. The lighting test circuit may include a first transistor which outputs a first test voltage to the first data line, and a third transistor which outputs a third test voltage to the third data line.

In the display device and the electronic apparatus according to the embodiments, the sub-pixel array may include the first sub-pixel column disposed adjacent to the first data line and in which the first sub-pixels and the third sub-pixels are alternately arranged, and a third sub-pixel column disposed adjacent to the third data line and in which the third sub-pixels and the first sub-pixels are alternately arranged, and the lighting test circuit may include the first and third transistors which output first and third test voltages to the first and third data lines, respectively, in response to the test gate signal, and thus, the lighting test circuit may be simplified, and an area of the lighting test circuit may be reduced.

### BRIEF DESCRIPTION OF THE DRAWINGS

Illustrative, non-limiting embodiments will be more clearly understood from the following detailed description taken in conjunction with the accompanying drawings.

FIG. 1 is a plan view showing a display device according to an embodiment.

FIG. 2 is a plan view showing a display area of FIG. 1.

FIG. 3 is a diagram showing data voltages applied to data lines of FIG. 2.

FIG. 4 is a circuit diagram showing a lighting test circuit of FIG. 1.

FIG. 5 is a layout showing the lighting test circuit of FIG. 4.

FIG. 6 is a plan view showing a display area of a display device according to a comparative example.

FIG. 7 is a diagram showing data voltages applied to data lines of FIG. 6.

FIG. 8 is a circuit diagram showing a lighting test circuit according to a comparative example.

FIG. 9 is a layout showing the lighting test circuit of FIG. 8.

FIG. 10 is a layout showing an example of an area A of FIG. 1.

FIG. 11 is a layout showing another example of the area A of FIG. 1.

FIG. 12 is a block diagram showing an electronic apparatus according to an embodiment.

### DETAILED DESCRIPTION OF THE EMBODIMENTS

Hereinafter, a display device and an electronic apparatus according to embodiments of the present disclosure will be described in more detail with reference to the accompanying drawings. The same or similar reference numerals will be used for the same elements in the accompanying drawings.

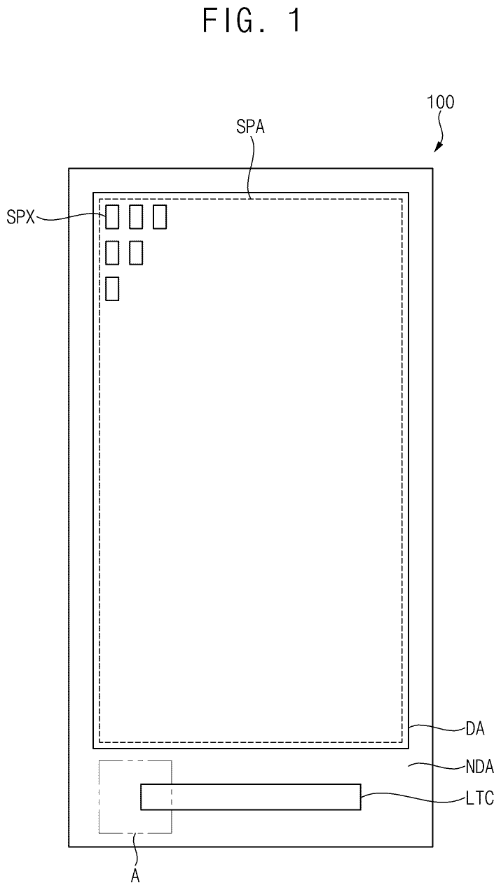

FIG. 1 is a plan view showing a display device 100 according to an embodiment.

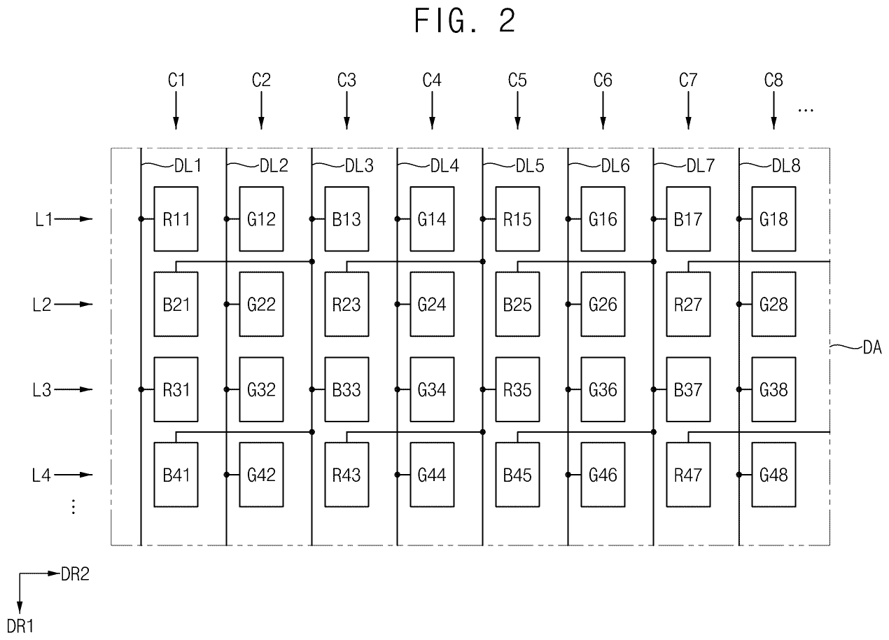

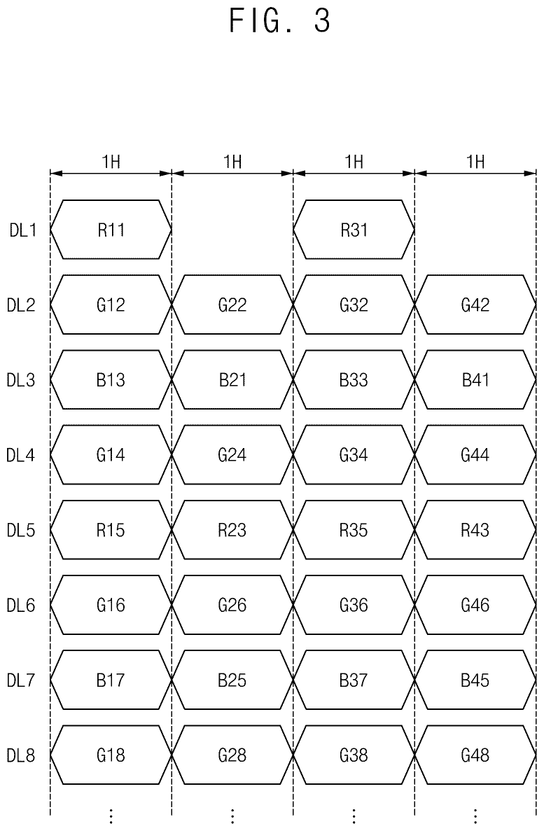

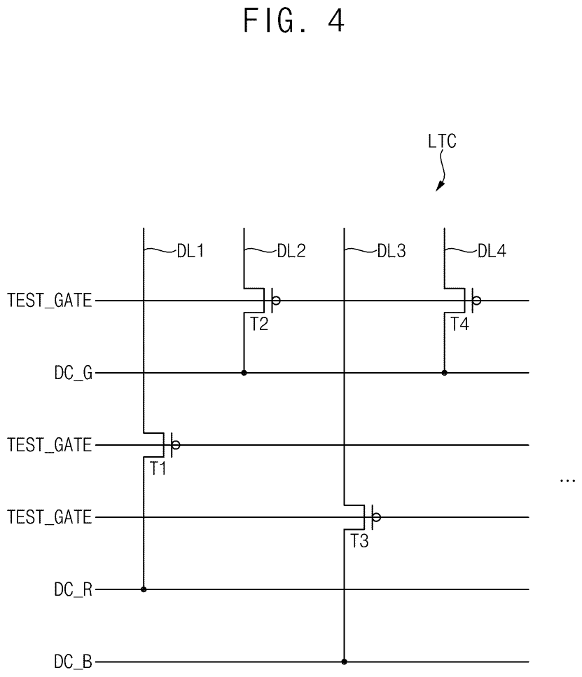

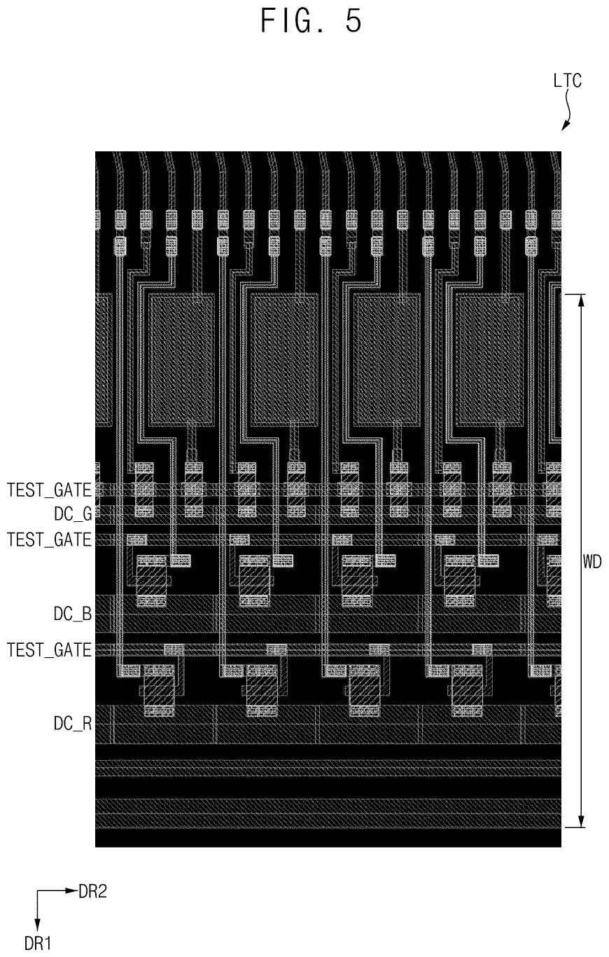

FIG. 2 is a plan view showing a display area DA of FIG. 1. FIG. 3 is a diagram showing data voltages applied to data lines DL1, . . . . DL8 of FIG. 2. FIG. 4 is a circuit diagram showing a lighting test circuit LTC of FIG. 1. FIG. 5 is a layout showing the lighting test circuit LTC of FIG. 4.

Referring to FIGS. 1 to 5, a display device 100 may include a plurality of data lines DL1, . . . , DL8, a sub-pixel array SPA, and a lighting test circuit LTC.

The data lines DL1, . . . , DL8 may extend in a first direction DR1, and may be arranged in a second direction DR2 intersecting the first direction DR1. The first to eighth data lines DL1, . . . , DL8 may be disposed in sequence in the second direction DR2. For example, the second data line DL2 may be disposed between the first data line DL1 and the third data line DL3, the third data line DL3 may be disposed between the second data line DL2 and the fourth data line DL4, and the fourth data line DL4 may be disposed between the third data line DL3 and the fifth data line DL5.

The sub-pixel array SPA may be disposed in a display area DA. The sub-pixel array SPA may include a plurality of sub-pixels SPX. In an embodiment, the sub-pixel array SPA may include first sub-pixels emitting light having a first color, second sub-pixels emitting light having a second color, and third sub-pixels emitting light having a third color.

In an embodiment, the first color may be one of red and blue, the second color may be green, and the third color may be the other of red and blue. In other words, the first sub-pixel may be one of a red sub-pixel and a blue sub-pixel, the second sub-pixel may be a green sub-pixel, and the third sub-pixel may be the other of the red sub-pixel and the blue sub-pixel.

In an embodiment, the first color may be one of green and blue, the second color may be red, and the third color may be the other of green and blue. In other words, the first sub-pixel may be one of the green sub-pixel and the blue sub-pixel, the second sub-pixel may be the red sub-pixel, and the third sub-pixel may be the other of the green sub-pixel and the blue sub-pixel.

In an embodiment, the first color may be one of red and green, the second color may be blue, and the third color may be the other of red and green. In other words, the first sub-pixel may be one of the red sub-pixel and the green sub-pixel, the second sub-pixel may be the blue sub-pixel, and the third sub-pixel may be the other of the red sub-pixel and the green sub-pixel.

Hereinafter, the first color, the second color, and the third color are described as being red, green, and blue, respectively. In other words, the first sub-pixel, the second sub-pixel, and the third sub-pixel are described as being the red sub-pixel, the green sub-pixel, and the blue sub-pixel, respectively.

The sub-pixel array SPA may include a first sub-pixel column C1 disposed adjacent to the first data line DL1, a second sub-pixel column C2 disposed adjacent to the second data line DL2, a third sub-pixel column C3 disposed adjacent to the third data line DL3, a fourth sub-pixel column C4 disposed adjacent to the fourth data line DL4, a fifth sub-pixel column C5 disposed adjacent to the fifth data line DL5, a sixth sub-pixel column C6 disposed adjacent to the sixth data line DL6, a seventh sub-pixel column C7 disposed adjacent to the seventh data line DL7, and an eighth sub-pixel column C8 disposed adjacent to the eighth data line DL8.

In the first sub-pixel column C1, the first sub-pixels R11 and R31 and the third sub-pixels B21 and B41 may be alternately arranged in the first direction DR1. In the second sub-pixel column C2, the second sub-pixels G12, G22, G32, and G42 may be arranged in the first direction DR1. In the third sub-pixel column C3, the third sub-pixels B13 and B33 and the first sub-pixels R23 and R43 may be alternately arranged in the first direction DR1. In the fourth sub-pixel column C4, the second sub-pixels G14, G24, G34, and G44 may be arranged in the first direction DR1. In the fifth sub-pixel column C5, the first sub-pixels R15 and R35 and the third sub-pixels B25 and B45 may be alternately arranged in the first direction DR1. In the sixth sub-pixel column C6, the second sub-pixels G16, G26, G36, and G46 may be arranged in the first direction DR1. In the seventh sub-pixel column C7, the third sub-pixels B17 and B37 and the first sub-pixels R27 and R47 may be alternately arranged in the first direction DR1. In the eighth sub-pixel column C8, the second sub-pixels G18, G28, G38, and G48 may be arranged in the first direction DR1.

The first sub-pixel of the first sub-pixel column C1 and the third sub-pixel of the third sub-pixel column C3 may be disposed in the same row extending in the second direction DR2. For example, the first sub-pixel R11 of the first sub-pixel column Cl and the third sub-pixel B13 of the third sub-pixel column C3 may be disposed in a first sub-pixel row L1, and the first sub-pixel R31 of the first sub-pixel column C1 and the third sub-pixel B33 of the third sub-pixel column C3 may be disposed in a third sub-pixel row L3.

The third sub-pixel of the first sub-pixel column Cl and the first sub-pixel of the third sub-pixel column C3 may be disposed in the same row extending in the second direction DR2. For example, the third sub-pixel B21 of the first sub-pixel column C1 and the first sub-pixel R23 of the third sub-pixel column C3 may be disposed in a second sub-pixel row L2, and the third sub-pixel B41 of the first sub-pixel column C1 and the first sub-pixel R43 of the third sub-pixel column C3 may be disposed in a fourth sub-pixel row L4.

The arrangement scheme of the above-described sub-pixels may be referred to as a PenTile™ type.

The first sub-pixels R11 and R31 of the first sub-pixel column C1 may be connected to the first data line DL1, and the third sub-pixels B21 and B41 of the first sub-pixel column C1 may be connected to the third data line DL3. The second sub-pixels G12, G22, G32, and G42 of the second sub-pixel column C2 may be connected to the second data line DL2. The third sub-pixels B13 and B33 of the third sub-pixel column C3 may be connected to the third data line DL3, and the first sub-pixels R23 and R43 of the third sub-pixel column C3 may be connected to the fifth data line DL5. The second sub-pixels G14, G24, G34, and G44 of the fourth sub-pixel column C4 may be connected to the fourth data line DL4. The first sub-pixels R15 and R35 of the fifth sub-pixel column C5 may be connected to the fifth data line DL5, and the third sub-pixels B25 and B45 of the fifth sub-pixel column C5 may be connected to the seventh data line DL7. Accordingly, the first data line DL1 may be connected to the first sub-pixels R11 and R31, the third data line DL3 may be connected to the third sub-pixels B13, B21, B33, and B41, and the fifth data line DL5 may be connected to the first sub-pixels R15, R23, R35, and R43.

The connection between the sub-pixels of the sixth to eighth sub-pixel columns C6, C7, and C8 and the data lines is substantially the same or similar to the connection between the sub-pixels of the second to fourth sub-pixel columns C2, C3, and C4 and the data lines, and thus, the description thereof is omitted.

When the display device 100 displays an image, as illustrated in FIG. 3, data voltages may be applied to the data lines DL1, . . . , DL8 in units of sub-pixel rows every horizontal time (1 H). The data voltages may be applied to the sub-pixels R11, G12, B13, G14, R15, G16, B17, and G18 of the first sub-pixel row L1 in a first horizontal time, the data voltages may be applied to the sub-pixels G22, B21, G24, R23, G26, B25, and G28 of the second sub-pixel row L2 in a second horizontal time, the data voltages may be applied to the sub-pixels R31, G32, B33, G34, R35, G36, B37, and G38 of the third sub-pixel row L3 in a third horizontal time, and the data voltages may be applied to the sub-pixels G42, B41, G44, R43, G46, B45, and G48 of the fourth sub-pixel row L4 in a fourth horizontal time.

Each of the data lines DL1, . . . , DL8 may be applied with the data voltage for one color. For example, the first and fifth data lines DL1 and DL5 may be applied with the data voltage for the first color, the second, fourth, sixth, and eighth data lines DL2, DL4, DL6, and DL8 may be applied with the data voltage for the second color, and the third and seventh data lines DL3 and DL7 may be applied with the data voltage for the third color.

The lighting test circuit LTC may be disposed in a non-display area NDA. The lighting test circuit LTC may include a first transistor T1 that outputs a first test voltage DC_R to the first data line DL1, a second transistor T2 that outputs a second test voltage DC_G to the second data line DL2, a third transistor T3 that outputs a third test voltage DC_B to the third data line DL3, and a fourth transistor T4 that outputs the second test voltage DC_G to the fourth data line DL4.

In an embodiment, the first transistor T1, the second transistor T2, the third transistor T3, and the fourth transistor T4 may be turned-on in response to a test gate signal TEST_GATE. Accordingly, the first transistor T1, the second transistor T2, the third transistor T3, and the fourth transistor T4 may be simultaneously turned-on/off.

The first transistor T1 may include a gate electrode receiving the test gate signal TEST_GATE, a first electrode receiving the first test voltage DC_R, and a second electrode connected to the first data line DL1. The first transistor T1 may output the first test voltage DC_R to the first data line DL1 in response to the test gate signal TEST_GATE.

The second transistor T2 may include a gate electrode receiving the test gate signal TEST_GATE, a first electrode receiving the second test voltage DC_G, and a second electrode connected to the second data line DL2. The second transistor T2 may output the second test voltage DC_G to the second data line DL2 in response to the test gate signal TEST_GATE.

The third transistor T3 may include a gate electrode receiving the test gate signal TEST_GATE, a first electrode receiving the third test voltage DC_B, and a second electrode connected to the third data line DL3. The third transistor T3 may output the third test voltage DC_B to the third data line DL3 in response to the test gate signal TEST_GATE.

The fourth transistor T4 may include a gate electrode receiving the test gate signal TEST_GATE, a first electrode receiving the second test voltage DC_G, and a second electrode connected to the fourth data line DL4. The fourth transistor T4 may output the second test voltage DC_G to the fourth data line DL4 in response to the test gate signal TEST_GATE.

When performing a lighting test for the first color of the display device 100, the test gate signal TEST_GATE may have an activation level, the first test voltage DC_R may have an activation level, and each of the second test voltage DC_G and the third test voltage DC_B may have a deactivation level. Accordingly, the first test voltage DC_R having the activation level may be output to the data lines DL1 and DL5 connected to the first sub-pixels of the sub-pixel array SPA, and the first sub-pixels of the sub-pixel array SPA may display the first color. Therefore, the lighting test for the first color of the display device 100 may be performed.

When performing a lighting test for the second color of the display device 100, the test gate signal TEST_GATE may have the activation level, the second test voltage DC_G may have the activation level, and each of the first test voltage DC_R and the third test voltage DC_B may have the deactivation level. Accordingly, the second test voltage DC_G having the activation level may be output to the data lines DL2, DL4, DL6, and DL8 connected to the second sub-pixels of the sub-pixel array SPA, and the second sub-pixels of the sub-pixel array SPA may display the second color. Therefore, the lighting test for the second color of the display device 100 may be performed.

When performing a lighting test for the third color of the display device 100, the test gate signal TEST_GATE may have the activation level, the third test voltage DC_B may have the activation level, and each of the first test voltage DC_R and the second test voltage DC_G may have the deactivation level. Accordingly, the third test voltage DC_B having the activation level may be output to the data lines DL3 and DL7 connected to the third sub-pixels of the sub-pixel array SPA, and the third sub-pixels of the sub-pixel array SPA may display the third color. Accordingly, the lighting test for the third color of the display device 100 may be performed.

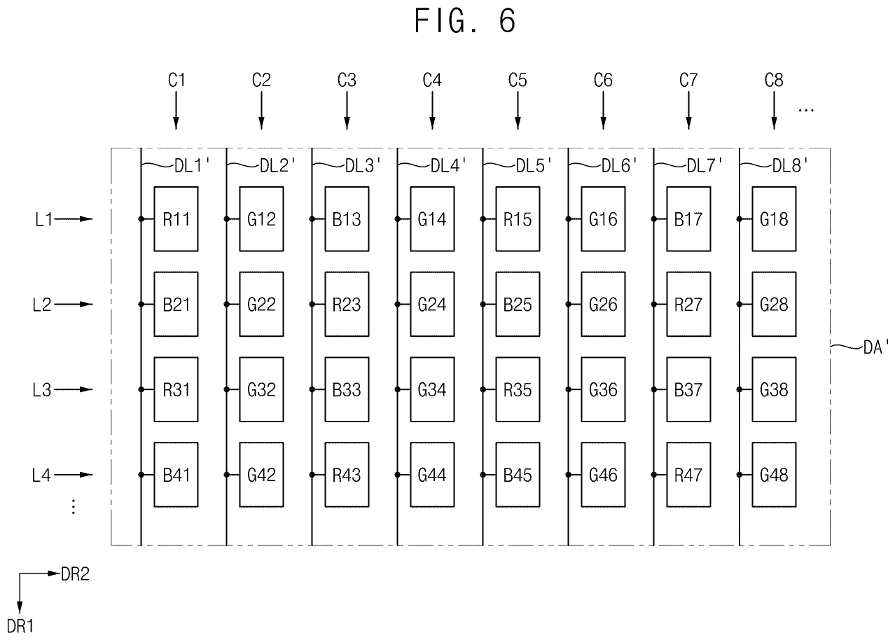

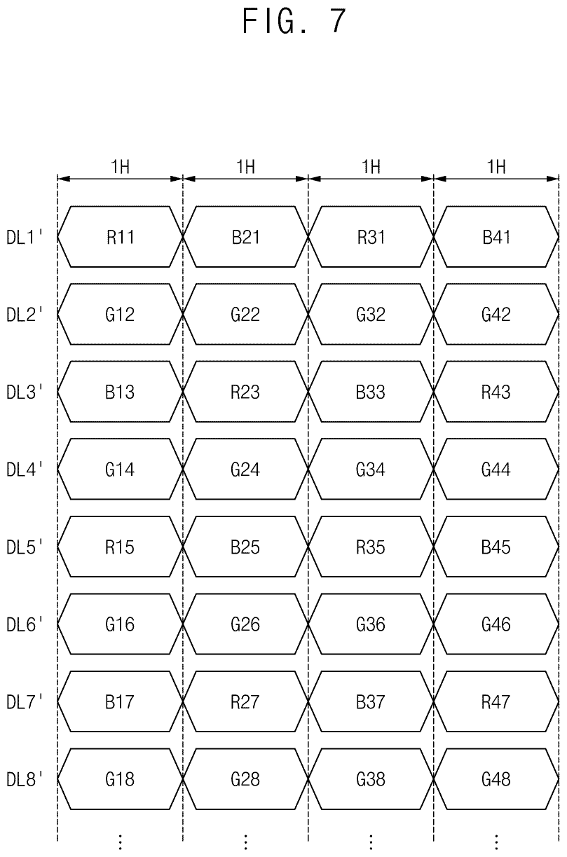

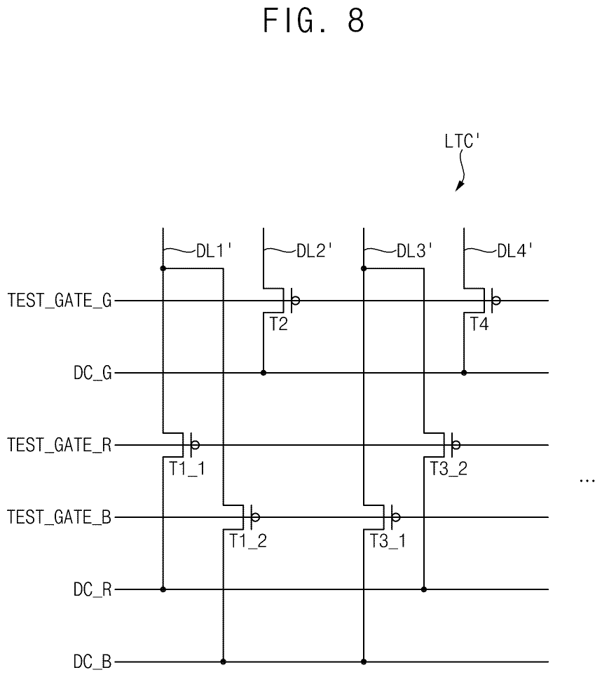

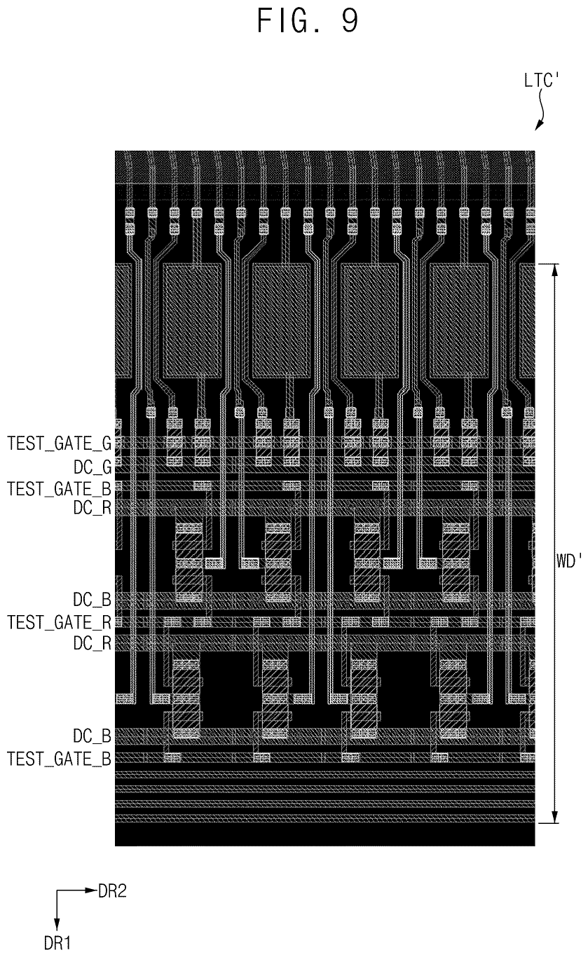

FIG. 6 is a plan view showing a display area DA′ of a display device according to a comparative example. FIG. 7 is a diagram showing data voltages applied to data lines DL1′, . . . . DL8′ of FIG. 6. FIG. 8 is a circuit diagram showing a lighting test circuit LTC′ according to a comparative example. FIG. 9 is a layout showing the lighting test circuit LTC′ of FIG. 8.

As illustrated in FIG. 6, in a comparative example, the first sub-pixels R11 and R31 and the third sub-pixels B21 and B41 of the first sub-pixel column C1 may be connected to the first data line DL1′, the third sub-pixels B13 and B33 and the first sub-pixels R23 and R43 of the third sub-pixel column C3 may be connected to the third data line DL3′, the first sub-pixels R15 and R35 and the third sub-pixels B25 and B45 of the fifth sub-pixel column C5 may be connected to the fifth data line DL5′, and the third sub-pixels B17 and B37 and the first sub-pixels R27 and R47 of the seventh sub-pixel column C7 may be connected to the seventh data line DL7′. Accordingly, the first data line DL1′ may be connected to the first sub-pixels R11 and R31 and the third sub-pixels B21 and B41, the third data line DL3′ may be connected to the third sub-pixels B13 and B33 and the first sub-pixels R23 and R43, the fifth data line DL5′ may be connected to the first sub-pixels R15 and R35 and the third sub-pixels B25 and B45, and the seventh data line DL7′ may be connected to the third sub-pixels B17 and B37 and the first sub-pixels R27 and R47.

When the display device according to the comparative example displays an image, as illustrated in FIG. 7, data voltages may be applied to the data lines DLI', . . . , DL8′ in units of sub-pixel rows for each horizontal time (1 H). The data voltage for the first color and the data voltage for the third color may be alternately applied to each of the first, third, fifth, and seventh data lines DL1′, DL3′, DL5′, and DL7′.

In the comparative example, since the data voltages for two colors are alternately applied to each of the first, third, fifth, and seventh data lines DL1′, DL3′, DL5′, and DL7′, power consumption of a buffer (e.g., amplifier) of a data driver that outputs the data voltage may increase. However, in the present embodiment, since the data voltage for one color is applied to each of the data lines DL1, . . . , DL8, the power consumption of the buffer of the data driver that outputs the data voltage may be reduced.

As illustrated in FIG. 8, a lighting test circuit LTC′ according to the comparative example may include a first-first transistor T1_1 that outputs the first test voltage DC_R to the first data line DL1′, a first-second transistor T1_2 that outputs the third test voltage DC_B to the first data line DL1′, a second transistor T2 that outputs the second test voltage DC_G to the second data line DL2′, a third-first transistor T3_1 that outputs the third test voltage DC_B to the third data line DL3′, a third-second transistor T3_2 that outputs the first test voltage DC_R to the third data line DL3′, and a fourth transistor T4 that outputs the second test voltage DC_G to the fourth data line DL4′.

In the lighting test circuit LTC′ according to the comparative example, the first-first transistor T1_1 and the third-second transistor T3_2 may be turned-on in response to a first test gate signal TEST_GATE_R, the second transistor T2 and the fourth transistor T4 may be turned-on in response to a second test gate signal TEST_GATE_G, and the first-second transistor T1_2 and the third-first transistor T3_1 may be turned-on in response to a third test gate signal TEST_GATE_B.

When comparing the lighting test circuit LTC according to the present embodiment with the lighting test circuit LTC′ according to the comparative example, the number of transistors T1, T2, T3, and T4 included in the lighting test circuit LTC according to the present embodiment may be smaller than the number of transistors T1_1, T1_2, T2, T3_1, T3_2, and T4 included in the lighting test circuit LTC′ according to the comparative example. Further, the number of signals TEST_GATE, DC_R, DC_G, and DC_B provided to the lighting test circuit LTC according to the present embodiment may be smaller than the number of signals TEST_GATE_R, TEST_GATE_G, TEST_GATE_B, DC_R, DC_G, and DC_B provided to the lighting test circuit LTC′ according to the comparative example. Accordingly, the lighting test circuit LTC according to the present embodiment may be simplified.

Since the number of transistors T1, T2, T3, and T4 included in the lighting test circuit LTC according to the present embodiment is smaller than the number of transistors T1_1, T1_2, T2, T3_1, T3_2, and T4 included in the lighting test circuit LTC′ according to the comparative example, an area occupied by the transistors T1, T2, T3, and T4 included in the lighting test circuit LTC according to the present embodiment may be smaller than an area occupied by the transistors T1_1, T1_2, T2, T3_1, T3_2, and T4 included in the lighting test circuit LTC′ according to the comparative example. Further, since the number of signals TEST_GATE, DC_R, DC_G, and DC_B provided to the lighting test circuit LTC according to the present embodiment is smaller than the number of signals TEST_GATE_R, TEST GATE G, TEST_GATE_B, DC_R, DC_G, and DC_B provided to the lighting test circuit LTC′ according to the comparative example, the number of signal lines connected to the lighting test circuit LTC according to the present embodiment may be smaller than the number of signal lines connected to the lighting test circuit LTC′ according to the comparative example. For example, as illustrated in FIGS. 5 and 9, a width WD of the lighting test circuit LTC according to the present embodiment in the first direction DR1 may be smaller than a width WD′ of the lighting test circuit LTC′ according to the comparative example in the first direction DR1. Accordingly, an area of the lighting test circuit LTC according to the present embodiment may be reduced.

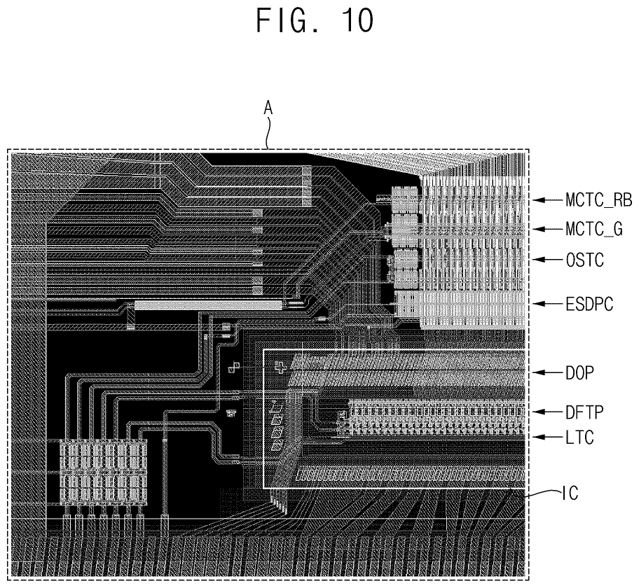

FIG. 10 is a layout showing an example of an area A of FIG. 1.

Referring to FIGS. 1 and 10, the display device 100 may further include a first module crack test circuit MCTC_RB, a second module crack test circuit MCTC_G, an open-short test circuit OSTC, an electrostatic discharge protection circuit ESDPC, data output pads DOP, DFT (Design For Test) pads DFTP, and an integrated circuit IC, which are disposed in the non-display area NDA.

The first module crack test circuit MCTC_RB and the second module crack test circuit MCTC_G may perform a crack test for a periphery of the display area DA. The first module crack test circuit MCTC_RB may be connected to at least one of the data lines connected to the first sub-pixel or the third sub-pixel, and the second module crack test circuit MCTC_G may be connected to at least one of the data lines connected to the second sub-pixel.

The open-short test circuit OSTC may perform an open-short test between adjacent data lines.

The electrostatic discharge protection circuit ESDPC may prevent static electricity from flowing into the display area DA through a signal line connected to an external input terminal disposed in the non-display area NDA.

The integrated circuit IC may be connected to the data output pads DOP and the DFT pads DFTP. The integrated circuit IC may be disposed to overlap the data output pads DOP and the DFT pads DFTP in a plan view. The integrated circuit IC may be mounted on a substrate of the display device 100 in a COG (Chip On Glass) manner or a COP (Chip On Plastic) manner. The integrated circuit IC may include the data driver and a DFT test circuit. The data driver may output the data voltages to the data output pads DOP, and the DFT test circuit may output DFT test voltages to the DFT pads DFTP.

In an embodiment, the lighting test circuit LTC may be disposed to overlap the integrated circuit IC in a plan view. In other words, the lighting test circuit LTC may be disposed inside the integrated circuit IC in a plan view. As illustrated in FIG. 10, when the lighting test circuit LTC is disposed to overlap the integrated circuit IC in a plan view, a dead space of the display device 100 may be reduced.

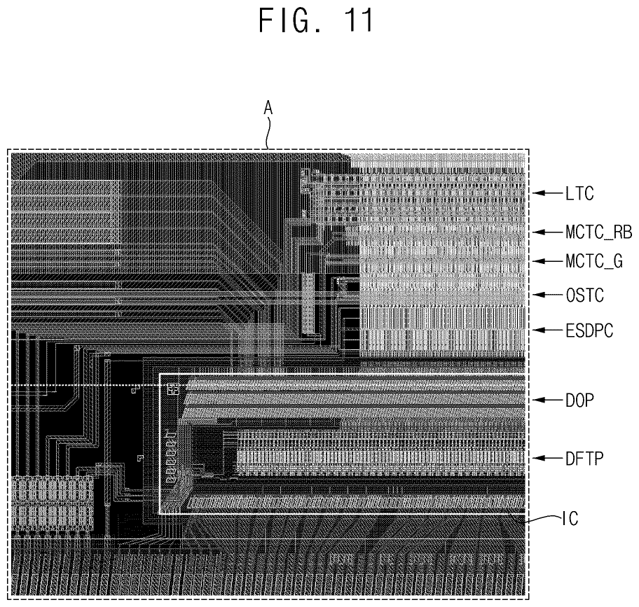

FIG. 11 is a layout showing another example of the area A of FIG. 1.

Referring to FIG. 11, in an embodiment, the lighting test circuit LTC may be disposed not to overlap the integrated circuit IC in a plan view. In other words, the lighting test circuit LTC may be disposed outside the integrated circuit IC in a plan view. As illustrated in FIG. 11, when there is insufficient space for the lighting test circuit LTC to be disposed in an area overlapping with the integrated circuit IC, the lighting test circuit LTC may be disposed not to overlap the integrated circuit IC in a plan view.

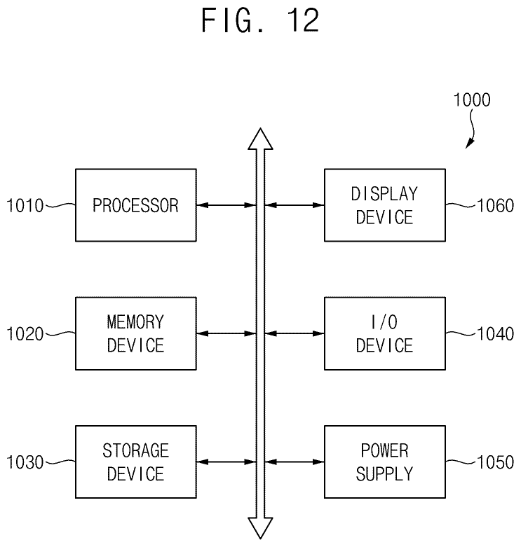

FIG. 12 is a block diagram showing an electronic apparatus according to an embodiment.

Referring to FIG. 12, an electronic apparatus 1000 may include a processor 1010, a memory device 1020, a storage device 1030, an input/output (I/O) device 1040, a power supply 1050, and a display device 1060. The electronic apparatus 1000 may further include a plurality of ports capable of communicating with a video card, a sound card, a memory card, a USB device, and the like, or communicating with other systems.

The processor 1010 may perform specific calculations or tasks. According to an embodiment, the processor 1010 may be a microprocessor, a central processing unit (CPU), or the like. The processor 1010 may be connected to other components through an address bus, a control bus, a data bus, and the like. According to an embodiment, the processor 1010 may also be connected to an expansion bus such as a peripheral component interconnect (PCI) bus. The processor 1010 may control the display device 1060.

The processor 1010 may control the display device 1060. In an embodiment, the processor 1010 may provide the first image data DAT1 of FIG. 1 and the control signal CTRL of FIG. 1 to the display device 1060.

The memory device 1020 may store data required for an operation of the electronic apparatus 1000. For example, the memory device 1020 may include: a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device such as a dynamic random access memory (DRAM), a static random access memory (SRAM), or a mobile DRAM.

The storage device 1030 may include a solid state drive (SSD), a hard disk drive (HDD), a CD-ROM, and the like. The I/O device 1040 may include: an input device such as a keyboard, a keypad, a touch pad, a touch screen, or a mouse; and an output device such as a speaker or a printer. The power supply 1050 may supply a power required for the operation of the electronic apparatus 1000. The display device 1060 may display an image. The display device 1060 may be connected to other components through the buses or other communication links. The display device 1060 may correspond to the display device 100 of FIG. 1.

The sub-pixel array of the display device 1060 may include a first sub-pixel column disposed adjacent to a first data line and in which first sub-pixels and third sub-pixels are alternately arranged, and a third sub-pixel column disposed adjacent to a third data line and in which third sub-pixels and first sub-pixels are alternately arranged, and a lighting test circuit of the display device 1060 may include first and third transistors which output first and third test voltages to the first and third data lines, respectively, in response to a test gate signal, and thus the lighting test circuit may be simplified, and an area of the lighting test circuit may be reduced. Accordingly, a dead space of the display device 1060 may be reduced.

The display device according to the embodiments may be applied to a display device included in a computer, a notebook, a mobile phone, a smart phone, a smart pad, a smart watch, a PMP, a PDA, an MP3 player, or the like.

Although the display device and the electronic apparatus according to the embodiments have been described with reference to the drawings, the shown embodiments arc examples, and may be modified and changed by a person having ordinary knowledge in the relevant technical field without departing from the technical spirit described in the following claims.

What is claimed is:

1. A display device, comprising:
a plurality of data lines extending in a first direction, the plurality of data lines including a first data line, a second data line, a third data line, a fourth data line, a fifth data line, a sixth data line and a seventh data line sequentially disposed in a second direction intersecting the first direction;
a sub-pixel array including first sub-pixels which emit light having a first color, second sub-pixels which emit light having a second color, and third sub-pixels which emit light having a third color; and
a lighting test circuit,
wherein the sub-pixel array includes:
a first sub-pixel column disposed adjacent to the first data line and in which first sub-pixels connected to the first data line and third sub-pixels connected to the third data line are alternately arranged in the first direction; and
a third sub-pixel column disposed adjacent to the third data line and in which third sub-pixels connected to the third data line and first sub-pixels connected to the fifth data line are alternately arranged in the first direction,
wherein the lighting test circuit includes:
a first transistor which outputs a first test voltage to the first data line; and
a third transistor which outputs a third test voltage to the third data line.

2. The display device of claim 1, wherein one of the first sub-pixels in the first sub-pixel column and one of the third sub-pixels in the third sub-pixel column are disposed in a same row extending in the second direction.

3. The display device of claim 1, wherein the sub-pixel array further includes:
a second sub-pixel column disposed adjacent to the second data line and in which second sub-pixels connected to the second data line are arranged in the first direction.

4. The display device of claim 3, wherein the lighting test circuit further includes:
a second transistor which outputs a second test voltage to the second data line.

5. The display device of claim 4, wherein the first transistor, the second transistor, and the third transistor are turned-on in response to a test gate signal.

6. The display device of claim 3, wherein the sub-pixel array further includes:
a fourth sub-pixel column disposed adjacent to the fourth data line and in which second sub-pixels connected to the fourth data line are arranged in the first direction.

7. The display device of claim 6, wherein the lighting test circuit further includes:
a fourth transistor which outputs a second test voltage to the fourth data line.

8. The display device of claim 6, wherein the sub-pixel array further includes:
a fifth sub-pixel column disposed adjacent to the fifth data line and in which first sub-pixels connected to the fifth data line and third sub-pixels connected to the seventh data line are alternately arranged in the first direction.

9. The display device of claim 8, wherein the first sub-pixels in the third sub-pixel column are connected to the fifth data line.

10. The display device of claim 1, wherein the first color is one of red and blue,
wherein the second color is green, and
wherein the third color is the other of red and blue.

11. The display device of claim 1, wherein the first color is one of green and blue,
wherein the second color is red, and
wherein the third color is the other of green and blue.

12. The display device of claim 1, wherein the first color is one of red and green,
wherein the second color is blue, and
wherein the third color is the other of red and green.

13. A display device, comprising:
a plurality of data lines extending in a first direction, the plurality of data lines including a first data line, a second data line, a third data line, a fourth data line and a fifth data line disposed in a second direction intersecting the first direction;
a sub-pixel array including first sub-pixels which emit light having a first color, second sub-pixels which emit light having a second color, and third sub-pixels which emit light having a third color; and
a lighting test circuit,
wherein the sub-pixel array includes:
a first sub-pixel column disposed adjacent to the first data line and in which first ones of the first sub-pixels and first ones of the third sub-pixels are alternately arranged in the first direction;
a second sub-pixel column disposed adjacent to the second data line and in which first ones of the second sub-pixels are arranged in the first direction; and
a third sub-pixel column disposed adjacent to the third data line and in which second ones of the third sub-pixels and second ones of the first sub-pixels are alternately arranged in the first direction,
wherein the lighting test circuit includes:
a first transistor which outputs a first test voltage to the first data line in response to a test gate signal;
a second transistor which outputs a second test voltage to the second data line in response to the test gate signal; and
a third transistor which outputs a third test voltage to the third data line in response to the test gate signal.

14. The display device of claim 13, wherein one of the first sub-pixels in the first sub-pixel column and one of the third sub-pixels in the third sub-pixel column are disposed in a same row extending in the second direction.

15. The display device of claim 13, wherein the sub-pixel array further includes:
a fourth sub-pixel column disposed adjacent to the fourth data line and in which second ones of the second sub-pixels are arranged in the first direction.

16. The display device of claim 15, wherein the lighting test circuit further includes:
a fourth transistor which outputs the second test voltage to the fourth data line in response to the test gate signal.

17. The display device of claim 15, wherein the sub-pixel array further includes:
a fifth sub-pixel column disposed adjacent to the fifth data line and in which third ones of the first sub-pixels and third ones of the third sub-pixels are alternately arranged in the first direction.

18. The display device of claim 17, wherein the first ones of the first sub-pixels in the first sub-pixel column are connected to the first data line,
wherein the first ones of the third sub-pixels in the first sub-pixel column and the second ones of the third sub-pixels in the third sub-pixel column are connected to the third data line, and
wherein the second ones of the first sub-pixels in the third sub-pixel column are connected to the fifth data line.

19. The display device of claim 13, wherein the first color is one of red and blue,
wherein the second color is green, and
wherein the third color is the other of red and blue.

20. An electronic apparatus including a display device which displays an image and a processor which controls the display device, the display device comprising:
a first data line, a second data line, a third data line, a fourth data line and a fifth data line extending in a first direction;
a sub-pixel array including first sub-pixels which emit light having a first color, second sub-pixels which emit light having a second color, and third sub-pixels which emit light having a third color; and
a lighting test circuit,
wherein the sub-pixel array includes:
a first sub-pixel column disposed adjacent to the first data line and in which first sub-pixels connected to the first data line and third sub-pixels connected to the third data line are alternately arranged in the first direction; and
a third sub-pixel column disposed adjacent to the third data line and in which third sub-pixels connected to the third data line and first sub-pixels connected to the fifth data line are alternately arranged in the first direction,
wherein the lighting test circuit includes:
a first transistor which outputs a first test voltage to the first data line; and
a third transistor which outputs a third test voltage to the third data line.
